(19) United States
(12) Patent Application Publication
(10) Pub. No.: US 2020/0387952 A1
(43) Pub. Date: Dec. 10, 2020

(54) METHOD AND APPARATUS FOR PREORDER OF FOOD ITEMS IN A CLOSED NETWORK GROUP AT A TRANSIT SERVICE STATION

(71) Applicant: Monginis Foods Pvt Ltd, Mumbai (IN)

(72) Inventor: Qusai Zoher KHORAKIWALA, Mumbai (IN)

(21) Appl. No.: 16/432,987

(22) Filed: Jun. 6, 2019

(51) Int. Cl. G06Q 30/06; G06Q 10/08; G06Q 50/12

(52) U.S. Cl. CPC G06Q 30/0633; G06Q 50/12; G06Q 10/0833; G06Q 30/0603

(57) ABSTRACT

The present invention provides a system, method and an apparatus for the pre-ordering of food items within a closed network group in a transit service station by ordering users in a food ordering system. The system comprises of a set of databases i.e. user database, food item vendor database, a food items listing database and a dietary preferences database; a set of modules i.e. a food order request module, a delivery preference module, a location module, a food delivery ETA module, a food items listing generator and a notification module. With this invention, the ordering user can pre-order food items within a closed network group in a transit service station in a food ordering system.

### BACKGROUND OF THE INVENTION

The current online food ordering system environment includes members like ordering users, receiving users, food vendors, and hospitality service providers. Many online food ordering systems, and online food ordering mobile applications allow users to select food items from restaurant menus based on the location of the user and to get the ordered food delivered at the desired location. Recently, online food ordering system providers enable the corresponding user to track of their respective food orders via a computer or mobile interface.

However, online food ordering systems, especially those offering online food ordering through mobile applications may disable pre-ordering of food items while connected to a closed network group at a transit service station, with all orders limited to the food vendors present within a close proximate location or boundary of the transit service station's authorized network, with delivery of the food items coordinated by the transit details of the passenger prior to departure for a predefined limited time. The cause, partly due to the fact that the current online food ordering system and the computer-implemented method or computer implemented interface adaptations like food ordering mobile applications disabled for ordering users to order food items from hyperlocal food vendors present within a close proximate location or boundary of the transit service station's authorized network coordinated with the time and logistical constraints of the departure timings of the ordering passengers.

Currently, there are systems that involve users to pre-order any item or food items based on information relating to a delivery time and a delivery location within the designated venue and involve transmitting the customer order to a vendor located at the designated venue. But these systems do not have any provision for listing the food items based on the delivery time and boarding time of the user.

US20180278462A1 relates to an interactive, electronic network that enables multi-level control, variable access, multi-user communications of real-time contextually relevant data or information among network-connected devices, and actions based on those communications, as the network-connected devices move from one location to another and/or the data/information flow among those devices change over time. However, the effectiveness and accuracy of the invention is limited. The food available for order is limited depending upon the availability of food item i.e. a food item is delivered for a fixed menu of a food establishment.

U.S. Ser. No. 10/078,861B1 relates to a method and apparatus for providing a centralized customer order processing system where the order entry is received by a central server and routed to a local store server at an identified store location. When customer reach at the location of identified store, mobile application invoked on the mobile device and order activation signal is transmitted to the server, thereafter customer order entry is activated at the local store server. Therefore, in this invention the customer has to arrive at the identified store location and pick up the order.

A user is restricted from pre order of food items while connected to a closed network group at a transit service station, with all orders limited to the food vendors present within a close proximate location or boundary of the transit service station's authorized network, with delivery of the food items coordinated by the transit details of the ordering passenger prior to departure for a predefined limited period of time.

### SUMMARY OF THE INVENTION

The present invention specifically relates to pre-ordering food items within a closed network group in a transit service station in a food ordering system.

Another aspect of the present invention is pre-ordering food items within a closed network group in a transit service station in a food ordering system wherein the transit service station is at least one among a railway station, an airport or a bus station.

Yet another aspect of the present invention is pre-ordering food items within a closed network group at a transit service station in a food ordering system, the orders limited to food vendors able to deliver at a time estimated to be before the boarding time of the ordering user.

Other objects and advantages of the present invention will become apparent from the following description taken in connection with the accompanying drawings, wherein, by way of illustration and example, the aspects of the present invention are disclosed.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is a functional block diagram of a food ordering system 100 according to one embodiment.

FIG. 2 is a block diagram of a food order request module 110 according to one embodiment.

FIG. 3 is a flow diagram of the method for pre-ordering food items within a closed network group in a transit service station in a food ordering system according to one embodiment.

FIG. 4 illustrates modules of an example machine 400 able to read instructions from a machine-readable medium and execute them in a processor (or controller) according to one embodiment according to one embodiment.

### DETAILED DESCRIPTION OF THE INVENTION

The following description describes various features and functions of the disclosed method and apparatus with reference to the accompanying figures. In the figures, similar symbols identify similar components, unless context dictates otherwise. The illustrative aspects described herein are not meant to be limiting.

These and other features and advantages of the present invention may be incorporated into certain embodiments of the invention and will become more fully apparent from the following description and claims or may be learned by the practice of the invention as set forth hereinafter. It may be readily understood that certain aspects of the disclosed system, method and apparatus can be arranged and combined in a wide variety of different configurations, all of which are contemplated herein.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention are provided for illustration purpose only and not for the purpose of limiting the invention.

It is to be understood that the singular forms “a,” “an,” and “the” include plural referents unless the context clearly dictates otherwise.

It should be emphasized that the term “comprises/comprising” when used in this specification is taken to specify the presence of stated features, integers, steps or components but does not preclude the presence or addition of one or more other features, integers, steps, components or groups thereof.

The Figures (FIGS.) and the following description relate to embodiments by way of illustration only. It should be noted that from the following discussion, alternative embodiments of the systems, methods, figures, diagrams and interfaces disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the systems, methods, figures, diagrams and interfaces illustrated herein may be employed without departing from the principles described herein. In the following description, for the purposes of explanation, numerous specific details are set forth in order to provide a thorough understanding of the various embodiments. It will be evident, however to one skilled in the art that the various embodiments may be practiced without these specific details.

### Configuration Overview

A system and method for pre-ordering food items within a closed network group in a transit service station in a food ordering system is provided. The food order request module in the food ordering system may comprise a plurality of modules and generators like a food order request module, a delivery preference module, a location module, a food delivery estimated time of arrival (ETA) module, a food items listing generator and a notification module. The method for pre-ordering food items within a closed network group in a transit service station in a food ordering system may comprise a plurality of steps like receiving a closed network group food order request at a transit service station from an ordering user, determining the predefined delivery preferences of the ordering user, determining the participating food vendors based on geographic location of service station, determining the subset of participating food vendors in the closed network group with delivery ETA earlier than the boarding time of the ordering user, generating the subset of food item listings from the subset of food vendors within the transit service station's geographical radius, and displaying the subset of food item listings from the subset of food vendors within transit service station geographical radius to the ordering user.

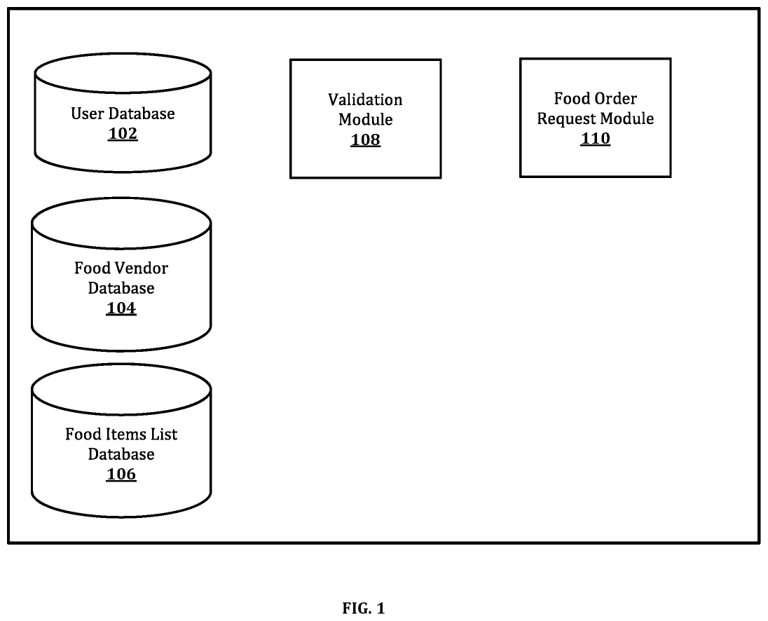

FIG. 1 is a block diagram of a food ordering system 100 according to one embodiment. The food ordering system 100 includes a variety of databases and modules for pre-ordering food items within a closed network group in a transit service station in a food ordering system 100. The closed network group food item listings are made available to users using the food order request module. Additional modules of the food ordering system 100 are described below.

The user database 102 may maintain information about each type of user based on the user's role in the system. The user information may be stored in a plurality of databases, each database associated with a user role, or the user roles may be stored in a single user database 102. For example, the additional user roles include ordering users, food item vending users, order receiving users, and other types of users of the food ordering system 100.

A user database 102 is further configured for receiving, storing, updating and retrieving a plurality of data fields of each user, such as the user's name, address, and contact details. Depending on the user's role in the food ordering system 100, the user database 102 maintains additional information on the user. For example, for an exemplary ordering user, the user database 102 maintains ordering history in the food ordering system 100.

In one embodiment, a distinct food vendor database 104 is configured for receiving, storing, updating and retrieving a plurality of data fields of each food items vendor, comprising the name of the food establishment, location within the transit service station, special offers and discounts, delivery timings, preferences, food items with corresponding dietary values, and/or criteria if any, along with payment mode.

In one embodiment, a distinct food items list database 106 is configured for receiving, storing, updating and retrieving a plurality of data fields of each closed network group food item listing, comprising the details of food items offered by each food establishment within the transit service station, specialty of the food item and availability of the food item, price, cuisine, and the associated dietary values of one serving of each such food item and other such food item criteria.

A validation module 108 is configured for validating the user credentials of the exemplary ordering users of the food ordering system 100.

A food order request module 110 is configured for pre-ordering food items within a closed network group in a transit service station in a food ordering system. In some embodiments, the transit service station is at least one among a railway station, an airport or a bus station. In other embodiments, the pre-ordering food items within a closed network group in a transit service station in a food ordering system further comprises limiting the orders to food vendors who have an estimated delivery time earlier than the boarding time of the ordering user.

In one embodiment, the user database 102, food vendor database 104, food items list database 106, and other databases form a single consolidated database in the food ordering system 100.

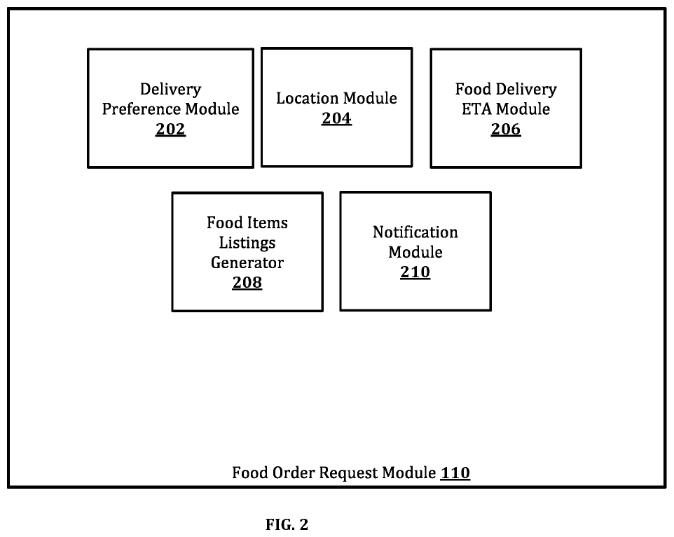

FIG. 2 is a block diagram of a food order request module 110 according to one embodiment. The food order request module 110 is configured for receiving, storing, retrieving and updating a plurality of closed network group pre-order food item listings within a closed network group in a transit service station in a food ordering system 100. In some embodiments, the closed network group pre-order food item listings may be accessed from a food items list database 106.

The delivery preference module 202 is configured for receiving, storing, retrieving and updating a plurality of delivery preferences predefined by exemplary food ordering users in the food ordering system 100.

The location module 204 is configured for receiving, storing, retrieving and generating a plurality of geographical locations of including but not limited to, locations of transit stations, user locations, and locations of food vendors in the food ordering system 100.

The food delivery ETA module 206 is configured for receiving, storing, retrieving and generating a plurality of estimated delivery times of a plurality of food item listings in the food ordering system 100.

The food items listings generator 208 is configured for receiving, storing, retrieving and generating a plurality of food item listings in the food ordering system 100.

The notification module 210 is configured for receiving, storing, retrieving and updating a plurality of notifications to be sent to exemplary food ordering users and exemplary food vendors.

Although the food order request module 110 is described as being composed of various modules, fewer or more modules (e.g. Logistical Preferences Module, a Pre-order Preference Module, a Location Proximity Module) may comprise the module with the present invention still falling within the scope of various embodiments.

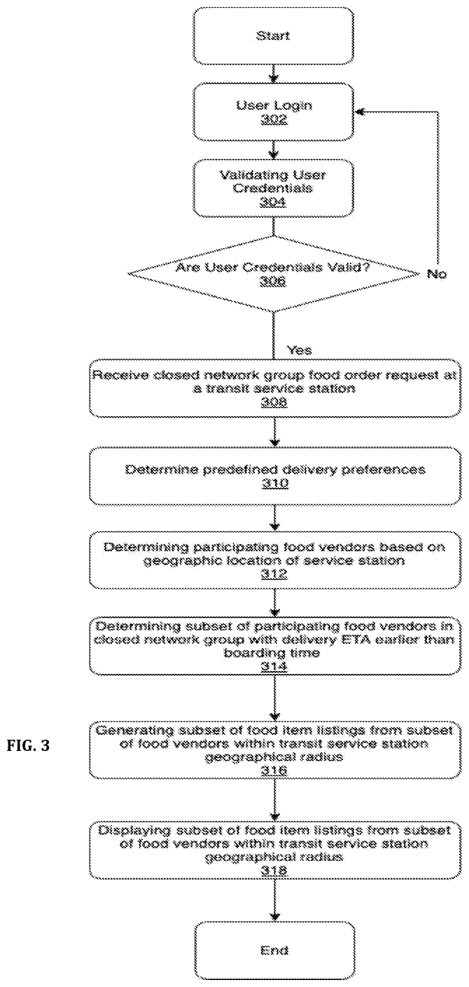

FIG. 3 is a flow diagram 300 of the method for pre-ordering food items within a closed network group in a transit service station in a food ordering system 100 according to one embodiment. At step 302, an exemplary ordering user logs into the food ordering system using an associated electronic user device. At step 304, the user credentials of the exemplary ordering user are validated. At step 306, provided the user credentials are valid, the exemplary user is allowed access to the food ordering system 100. If the user credentials are not valid, the exemplary user is denied access to the food ordering system 100.

At step 308, a closed network group food order request is received via the food order request module 110 at the transit service station. At step 310, the predefined delivery preferences are determined by the delivery preference module 202 comprising at least one seat number, at least one vehicle identification number, at least one gate/platform number, and at least one boarding time. At step 312, the available and participating food vendors are determined by the location module 204, based on the location of the food vendor and the transit service station. At step 314, the available and participating food vendors are determined by the food delivery ETA module 206, based on the estimated delivery time being earlier than the boarding time. At step 316, a subset of food item listings are generated by the food item listings generator 208 within the predefined geographical radius and wherein the delivery time is before the boarding time of the user at the transit service station. At step 318, a subset of food item listings is displayed by the food item listings generator 208 within the predefined geographical radius and wherein the delivery time is before the boarding time of the user at the transit service station.

Although the food ordering system 100 is described as being composed of various components like databases and modules, the food ordering system 100 may comprise fewer or more databases, components, and other modules. For example, the food ordering system 100 may include a Logistical Preferences Module, a Pre-order Preference Module or a Location Proximity Module with the present disclosure still falling within the scope of various embodiments. In some embodiments, an individual or group may play a plurality of user roles on the food ordering system, with the present disclosure still falling within the scope of various embodiments.

In various embodiments the food ordering system 100 may be any of a web application, a mobile application, or an embedded module or subsystem of a an online food ordering environment, a mobile food ordering environment, an electronic commerce system, an electronic payments system, a mobile operating system, a computer based operating system, or of a tablet based operating system, with the present disclosure still falling within the scope of various embodiments.

It is appreciated that, in some embodiments, various databases like 102, 104, 106, modules 110, 202, 204, 206, 208, 210 as well as the databases, engines, modules and components of the above embodiments may be stored in the form of machine readable instructions in the memory of the food ordering system 100 and executed by a processor of the food ordering system 100 to perform one or more embodiments disclosed herein. Alternatively, the various databases like 102, 104, 106, modules 110, 202, 204, 206, 208, 210 as well as the databases, engines, modules and components of the above embodiments may be implemented in the food ordering system 100 in the form of an apparatus configured to perform one or more embodiments disclosed herein.

The online food ordering system environment includes a food ordering system 100 according to one embodiment. The food ordering system 100 operates in the online food ordering system environment and communicates with a plurality of exemplary user devices over an exemplary network. The exemplary user devices are operated by a plurality of kinds of users in the online food ordering system environment. The exemplary user devices may comprise any of a variety of computing devices, such as a desktop computer, a laptop, a mobile device, a tablet computer, a set-top box, a kiosk, interactive television, gaming console, and other computing platforms suitable for communicating with food ordering system 100. The food ordering system 100 provides a system for pre-ordering food items within a closed network group in a transit service station to ordering users in a food ordering system. The food ordering system 100 enables the various users to communicate and transact with other users in an online food ordering system environment and provide services to other users. The exemplary network includes a wireless area network, a local area network, a General Packet Radio Service (GPRS) network, an Enhanced Data for Global Evolution (EDGE) network and the like. The exemplary user devices are connected to the food ordering system 100 via an exemplary network.

Although the online food ordering system environment is described as being composed of various, user devices (e.g., personal computer), a network (e.g., internet, intranet, world wide web), it would be appreciated by one skilled in the art that fewer or more kinds of users, user devices (e.g., a mobile phone device, a portable gaming console device, a tablet device, a learning console device, gaming console device or server device attached to a television or other screen) and networks (e.g., an intranet at hospitality service providers, restaurants, fashion products ordering platforms, FMCG, groceries and essential products ordering platforms and local travel booking platforms) may comprise the online food ordering system environment, with the present disclosure still falling within the scope of various embodiments.

Computing Machine Architecture

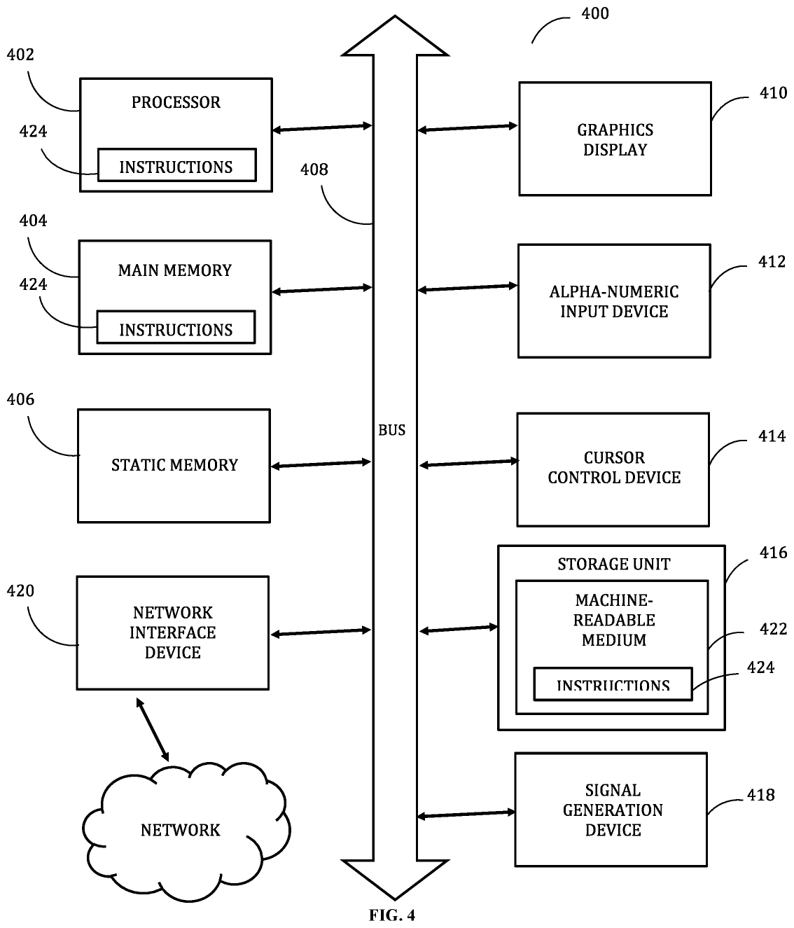

FIG. 4 is a block diagram illustrating modules of an example machine suitable for use as a food ordering system 100, in which any of the embodiments disclosed herein may be performed, according to one embodiment. This example machine is able to read instructions from a machine-readable medium and execute them in a processor (or controller).

Specifically, FIG. 4 shows a diagrammatic representation of a machine in the example form of a computer system 400 within which instructions 424 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 which carries out the computer-implemented method includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include a graphics display unit 410 (e.g., a plasma display panel (PDP), a liquid crystal display (LCD), a projector, or a cathode ray tube (CRT)). The computer system 400 may also include alphanumeric input device 412 (e.g., a keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over an exemplary network via the network interface device 420.

While machine readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

The food ordering system 100 may be one or more servers in which one or more methods disclosed herein are performed. The processor 402 may be a microprocessor, a state machine, an application specific integrated circuit, a field programmable gate array, etc. (e.g., Intel® Pentium® processor). The main memory 404 may be a dynamic random access memory and/or a primary memory of the food ordering system 100. The static memory 406 may be a hard drive, a flash drive, and/or other memory information associated with the food ordering system 100.

The bus 408 may be an interconnection between various circuits and/or structures of the food ordering system 100. The video display 410 may provide graphical representation of information on the food ordering system 100. The alphanumeric input device 412 may be a keypad, keyboard and/or any other input device. The cursor control device 414 may be a pointing device such as a mouse.

The storage unit 416 may be a hard drive, a storage system, and/or other longer term storage subsystem. The signal generation device 418 may be a bios and/or a functional operating system of the food ordering system 100. The network interface device 420 may be a device that may perform interface functions such as code conversion, protocol conversion and/or buffering required for communication to and from a network. The machine readable medium 422 may provide instructions 424 on which any of the methods disclosed herein may be performed. The instructions 424 may provide source code and/or data code to the processor 402 to enable any one/or more operations disclosed herein. For example, the food ordering system 100 may be stored in the form of instructions 424 on a storage medium such as the main memory 404 and/or the machine readable medium 422 such as compact disk.

In one embodiment, a non-transitory computer-readable storage medium having tangibly embodied thereon a program of instructions executable by a processor or a computing device (e.g., the food ordering system 100) causes the computing device to perform method steps illustrated in FIG. 3.

### Additional Configuration Considerations

Throughout this specification, plural instances may implement modules, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate modules in example configurations may be implemented as a combined structure or module. Similarly, structures and functionality presented as a single module may be implemented as separate modules. These and other variations, modifications, additions, and improvements fall within the scope of the subject matter herein.

Certain embodiments are described herein as including functionality implemented in computing logic or a number of components, modules, or mechanisms, for example, as illustrated in FIGS. 1, 2, and 3. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 402, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

In another embodiment, the food order request interface provided by the food ordering system 100 can be accessed over a local area network, intranet or virtual private network accessible to a limited plurality of user devices of hospitality service providers, restaurants, fashion products ordering platforms, FMCG, groceries and essential products ordering platforms and local travel booking platforms. through a user device.

In another embodiment, food order request interface provided by the food ordering system 100 can be accessed over a wide area network, General Packet Radio Service network, an Enhanced Data for Global Evolution network, a 3G telecommunications network, a 4G LTE telecommunications network or other telecommunications network through a user device.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although the present embodiments have been described with reference to specific example embodiments, it will be evident that various modifications and changes may be made to these embodiments without departing from the broader spirit and scope of the various embodiments. For example, the various devices, modules, databases, etc. described herein may be enabled and operated using hardware circuitry (e.g., complementary metal-oxide-semiconductor (CMOS) based logic circuitry), firmware, software and/or any combination of hardware, firmware, and/or software (e.g., embodied in a machine readable medium).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine modules that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and modules of the embodiments herein. This is done merely for convenience and to give a general sense of the invention. This description should be read to include one or at least one and the singular also includes the plural unless it is obvious that it is meant otherwise.

According to the embodiments described in FIG. 1 through 3, various methods and electric structures may be embodied using transistors, logic gates, and electrical circuits (e.g., Application Specific Integrated Circuitry and/or in Digital Signal Processor circuitry). For example, the food order request module and other modules of FIGS. 1 to 3 may be enabled using a food order request circuit and other circuits using one or more of the technologies described herein. In addition, it will be appreciated that the various operations, processes, and methods disclosed herein may be embodied in a machine-readable medium and/or a machine accessible medium compatible with a data processing system (e.g., a server) and may be performed in any order. Accordingly, the specification and drawings are to be regarded in an illustrative rather than a restrictive sense.

Upon reading this disclosure, those of skill in the art will appreciate still additional alternative structural and functional designs for a system and a method for pre-ordering food items within a closed network group in a transit service station in a food ordering system through the disclosed principles herein. Thus, while particular embodiments and applications have been illustrated and described, it is to be understood that the disclosed embodiments are not limited to the precise construction and modules disclosed herein. Various modifications, changes and variations, which will be apparent to those, skilled in the art, may be made in the arrangement, operation and details of the method and apparatus disclosed herein without departing from the spirit and scope defined in the appended claims.

1. A method for pre-ordering food items within a closed network group at a transit service station in a food ordering system, the system including one or more processors and a plurality of electronic user devices, the plurality of electronic user devices being remotely linked over a computer network through a network interface device configured to perform functions enabling communication to and from the computer network via a mobile or browser-based web application, a computer desktop application, an electronic module or subsystem of an online food ordering environment, a travel booking environment, a station's local wireless intranet environment, a hotel reservation environment, a mobile environment, an electronic commerce system, an electronic payments system, a mobile application or an Internet based website, each of the plurality of user computing devices including an electronic user interface and an electronic display, the one or more processors configured with one or more computer-implemented modules or generators including a validation module, a food order request module, a delivery preference module, a location module, a food delivery Estimated Time of Arrival (ETA) module, a food items listings generator, a notification module, a user database, a food vendor database, a food items list database, the method comprising:
receiving, via the food order request module, at least one food order request from an electronic device associated with at least one ordering user, wherein the user device is connected to a closed network group within a transit service station;
determining, via the delivery preference module, the predefined delivery preference from the electronic user device associated with the ordering user, wherein the delivery preference comprises of at least one seat number, at least one vehicle identification number, at least one gate/platform number, and at least one boarding time;
locating at least one participating food vendor from the plurality of food vendors based on the geographical location of the transit station;
determining, via the food delivery ETA module, at least one participating food vendor from the plurality of food vendors at a delivery time before the boarding time;
responsive to the determination of participating food vendors,
generating, via the food item listings generator, a list comprising at least one available food item from a plurality of food items listed by food vendors within the predefined geographical radius and wherein the delivery time is before the boarding time of the user at the transit service station;
denying, via the food item listings generator, access to food items listed by food vendors that are not within the predefined geographical radius and wherein the estimated delivery time is after the boarding time of the user at the transit service station; and
displaying, via the food item listings generator, the list comprising at least one available food item from the plurality of food items listed by food vendors within the predefined geographical radius and wherein the delivery time is before the boarding time of the user at the transit service station on the electronic device associated with the ordering user.

2. The method of claim 1, wherein the transit service station is at least one among a railway station, an airport or a bus station.

3. A non-transitory computer readable storage medium having tangibly embodied thereon a program of instructions executable by a processor for pre-ordering food items within a closed network group in a transit service station in a food ordering system, the system including one or more processors and a plurality of electronic user devices, the plurality of electronic user devices being remotely linked over a computer network through a network interface device configured to perform functions enabling communication to and from the computer network via a mobile or browser-based web application, a computer desktop application, an electronic module or subsystem of an online food ordering environment, a travel booking environment, a station's local wireless intranet environment, a hotel reservation environment, a mobile environment, an electronic commerce system, an electronic payments system, a mobile application or an Internet-based website, each of the plurality of user computing devices including an electronic user interface and an electronic display, the one or more processors configured with one or more computer-implemented modules or generators including a validation module, a food order request module, a delivery preference module, a location module, a food delivery ETA module, a food items listings generator, a notification module, a user database, a food vendor database, a food items list database, instructions when executed causing the processor to perform steps of:
receiving, via the food order request module, at least one food order request from an electronic device associated with at least one ordering user, wherein the user device is connected to a closed network group within a transit service station;
determining, via the delivery preference module, the predefined delivery preference from the electronic user device associated with the ordering user, wherein the delivery preference comprises of at least one seat number, at least one vehicle identification number, at least one gate/platform number, and at least one boarding time;
determining, via the location module, at least one participating food vendor from a plurality of food vendors based on the geographical location of the transit station;
determining, via the food delivery ETA module, at least one participating food vendor from the plurality of food vendors at a delivery time before the boarding time;
responsive to the determination of participating food vendors,
generating, via the food item listings generator, a list comprising at least one available food item from a plurality of food items listed by food vendors within the predefined geographical radius and wherein the delivery time is before the boarding time of the user at the transit service station;
denying, via the food item listings generator, access to food items listed by food vendors that are not within the predefined geographical radius and wherein the estimated delivery time is after the boarding time of the user at the transit service station; and
displaying, via the food item listings generator, a list comprising at least one available food item from a plurality of food items listed by food vendors within the predefined geographical radius and wherein the delivery time is before the boarding time of the user at the transit service station on the electronic device associated with the ordering user.

4. The non-transitory computer readable storage medium of claim 3, wherein the transit service station is at least one among a railway station, an airport or a bus station.

5. An apparatus comprising:
a network interface configured for pre-ordering food items within a closed network group in a transit service station in a food ordering system,
a processor coupled to the network interface,
a memory coupled to the processor, wherein the memory comprises instructions for execution on the processor to perform steps of:
receiving, via the food order request module, at least one food order request from an electronic device associated with at least one ordering user, wherein the user device is connected to a closed network group within a transit service station;
determining, via the delivery preference module, the predefined delivery preference from the electronic user device associated with the ordering user, wherein the delivery preference comprises of at least one seat number, at least one vehicle identification number, at least one gate/platform number, and at least one boarding time;
determining, via the location module, at least one participating food vendor from a plurality of food vendors based on the geographical location of the transit station;
determining, via the food delivery ETA module, at least one participating food vendor from the plurality of food vendors at a delivery time before the boarding time;
responsive to the determination of participating food vendors,
generating, via the food item listings generator, a list comprising at least one available food item from a plurality of food items listed by food vendors within the predefined geographical radius and wherein the delivery time is before the boarding time of the user at the transit service station;
denying, via the food item listings generator, access to food items listed by food vendors that are not within the predefined geographical radius and wherein the estimated delivery time is after the boarding time of the user at the transit service station; and
displaying, via the food item listings generator, a list comprising at least one available food item from a plurality of food items listed by food vendors within the predefined geographical radius and wherein the delivery time is before the boarding time of the user at the transit service station on the electronic device associated with the ordering user.

6. The apparatus of claim 5, wherein the transit service station is at least one among a railway station, an airport or a bus station.
